(19) United States
(12) Patent Application Publication
(10) Pub. No.: US 2005/0102141 A1
(43) Pub. Date: May 12, 2005

(54) Voice operation device

(75) Inventor: Takayoshi Chikuri, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 10/965,866

(22) Filed: Oct. 18, 2004

(30) Foreign Application Priority Data
Nov. 11, 2003 (JP) 2003-381483

(51) Int. Cl. G10L 15/00

(52) U.S. Cl. 704/244

(57) ABSTRACT

Voice operation device includes: voice recognition dictionary for storing plurality of groups of synonyms provided for plurality of functions of devices to be operated and each includes at least one word; voice recognition unit that checks voice data from voice taking unit against words stored in voice recognition dictionary to recognize word corresponding to voice; device control unit that controls devices to be operated based on word recognized by voice recognition unit; recognition history storage unit that sequentially stores words recognized by voice recognition unit; and dictionary update unit that updates voice recognition dictionary in such way that words which are determined to have been recognized at low frequencies in the past, based on recognition history stored in recognition history storage unit, are deleted except at least one of word which is left in each group of plurality of groups of synonyms in order to be checked.

### BACKGROUND OF THE INVENTION

1. Field of the Invention

The present invention relates to a voice operation device for operating a device which is to be operated, by use of voice and, in particular, to a technology for maintaining words of synonyms (words or phrases which have same meaning) in a voice recognition dictionary that is used for voice recognition.

2. Description of the Related Art

A voice operation device which is used for operating a vehicle mounted device such as vehicle mounted audio device and air conditioning device has been conventionally known (for example, see patent document 1). In this voice operation device, a device to be operated is designated by use of a manually operated switch or the like and this designated device to be operated is operated by use of voice. This voice operation device is provided with a plurality of voice recognition dictionaries which are respectively corresponding to a plurality of vehicle mounted devices, and the voice recognition dictionaries are switched according to the designated device to be operated. In the voice recognition dictionary, a plurality of words of synonyms are prepared for one function of each device to be operated.

In the voice operation device like this, input voice is checked against the plurality of words in the voice recognition dictionary and a word that is the most similar to the input voice is adopted as an operation command for the device to be operated. In general, as words which are prepared for one function increase in number, a probability of hitting the function at the time of checking increases whereas the rate of voice recognition decreases. However, according to this voice operation device, in a case where a plurality of devices to be operated are operated by use of voice input, only a voice recognition dictionary corresponding to each device to be operated is made effective, so that words to be checked can be decreased in number. As a result, this can enhance the rate of voice recognition. [Patent document 1] Japanese Unexamined Patent Publication No. 9-34488

However, in the conventional voice operation device described above, an operator is forcibly required to select a device to be operated, which results in increasing load applied to the operator. Further, there is presented a problem that because words which are not related to the designated device to be operated, are not used, functions to be operated by use of voice are decreased in number to impair the ease of use.

### SUMMARY OF THE INVENTION

The present invention has been made to solve the above described problem and the object of the present invention is to provide a voice operation device that can easily operate a device to be operated and is excellent in the ease of use.

A voice operation device in accordance with the present invention includes: a voice taking unit that takes in voice; a voice recognition dictionary for storing a plurality of groups of synonyms which are provided for a plurality of functions of a device to be operated and each of which includes at least one word; a voice recognition unit that checks voice data taken in by the voice taking unit against the words stored in the voice recognition dictionary to recognize a word corresponding to the voice; a device control unit that controls the device to be operated on the basis of the word recognized by the voice recognition unit; a recognition history storage unit that sequentially stores the words recognized by the voice recognition unit as recognition history; and a dictionary update unit that updates the voice recognition dictionary in such a way that words which are determined to have been recognized at low frequencies in the past on the basis of the recognition history stored in the recognition history storage unit, are deleted except at least one of the word which is left in each group of the plurality of groups of synonyms in order to be checked.

Therefore, according to the present invention, an operation of selecting a group of synonyms corresponding to the device to be operated so as to enhance the rate of voice recognition is not required. Therefore, in contrast to the conventional voice operation device, an operator is not forcibly required to select the device to be operated but can easily operate the device to be operated.

Further, the voice operation device in accordance with the present invention is arranged in such a way as to delete words, which were recognized at low frequencies in the past, from words to be checked on the basis of recognition history and, in a case where all of the words included in the group of synonyms corresponding to a certain function are deleted from words to be checked when this deletion is performed, in such a way as to leave at least one word as the word to be checked. Therefore, this can decrease the words to be checked in number and hence can enhance the rate of voice recognition and at the same time can prevent a specific function from being unable to be performed. Further, by deleting the words which were recognized at low frequencies in the past from the words to be checked, it is possible to prevent the ease of use from being impaired.

### BRIEF DESCRIPTION OF THE DRAWINGS

FIG. 1 is a block diagram to show the structure of a voice operation device in accordance with embodiment 1 of the present invention.

FIG. 2 is an illustration to show a specific example of a voice recognition dictionary used in the voice operation device in accordance with embodiment 1 of the present invention.

FIG. 3 is a flow chart to show an outline of a voice recognition processing in the voice operation device in accordance with embodiment 1 of the present invention.

FIG. 4 is a flow chart to show details of a dictionary update processing shown in FIG. 3.

FIG. 5 is an illustration to show one example of recognition history which is stored in recognition history storage unit of the voice operation device in accordance with embodiment 1 of the present invention.

FIG. 6 is an illustration to describe the voice update processing performed by the voice operation device in accordance with embodiment 1 of the present invention by use of specific examples.

FIG. 7 is an illustration to describe the voice recognition dictionary updated by the voice update processing performed by the voice operation device in accordance with embodiment 1 of the present invention.

### DETAILED DESCRIPTION OF THE PREFERRED EMBODIMENTS

Hereinafter one embodiment of the present invention will be described in detail with reference to the drawings.

### Embodiment 1

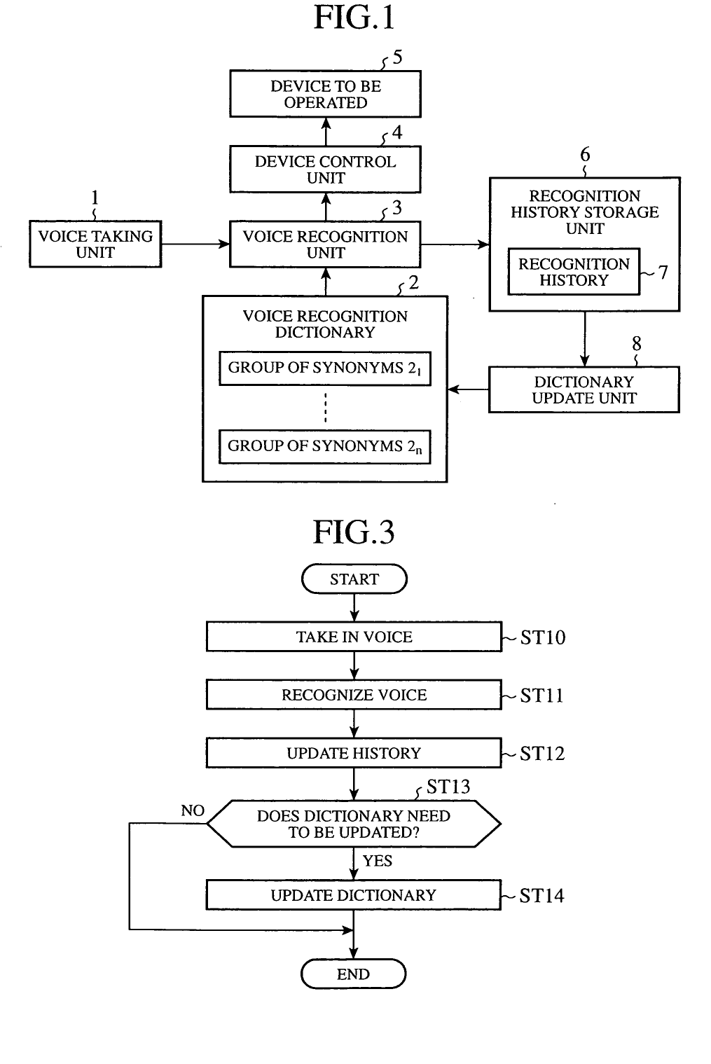

FIG. 1 is a block diagram to show the structure of a voice operation device in accordance with embodiment 1 of the present invention. This voice operation device is composed of a voice taking unit 1, a voice recognition dictionary 2, a voice recognition unit 3, a device control unit 4, some devices 5 to be operated, a recognition history storage unit 6, and a dictionary update unit 8. As for the device to be operated 5, can be used a plurality of vehicle mounted type devices such as navigation device, an audio device, and the other electronic devices. In the below described Embodiment, example is explained about the navigation device and the audio device as for the vehicle mounted type devices, and when the Embodiment is described as device to be operated without specific restriction, it means any one of navigation device and audio device.

The voice taking unit 1 produces voice data including, for example, a character string on the basis of a voice signal obtained by converting voice input, for example, from a microphone to an electric signal. The voice date produced by the voice taking unit 1 is sent to the voice recognition unit 3.

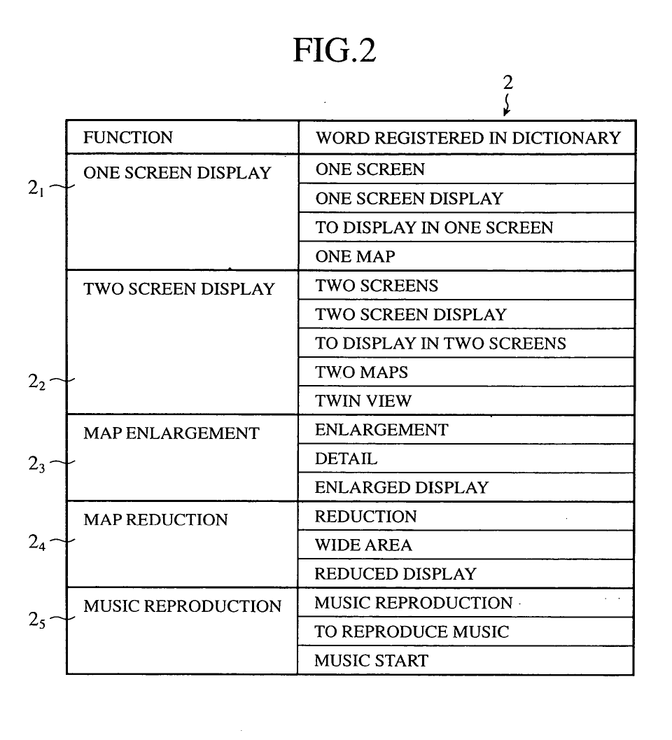

The voice recognition dictionary 2 stores a plurality of groups 21 to 2n of synonyms (where n is a positive integer) to control functions which are included in the device to be operated 5 for each of every functions. FIG. 2 shows a specific example of the voice recognition dictionary 2. For example, in the group 21 of synonyms to control a one screen display function of the device to be operated 5 are registered four words of “one screen”, “one screen display”, “to display in one screen”, and “one map”. Similarly, in the group 22 of synonyms to control a two screen display function are registered five words of “two screens”, “two screen display”, “to display in two screens”, “two maps”, and “twin view”.

In the group 23 of synonyms to control a map enlargement function are registered three words of “enlargement”, “detail”, and “enlarged display”. In the group 24 of synonyms to control a map reduction function are registered three words of “reduction”, “wide area”, and “reduced display”. In the group 25 of synonyms to control a music reproduction function are registered three words of “music reproduction”, “to reproduce music”, and “music start”.

The voice recognition unit 3 checks the voice data which is sent from the voice taking unit 1 against the words which is registered in the groups 21 to 2n of synonyms of the voice recognition dictionary 2 and outputs the word that is the closest to the voice data as a recognition result. The word recognized by this voice recognition unit 3 is sent to the device control unit 4 and to the recognition history storage unit 6.

The device control unit 4 interprets the word sent as an operation command from the voice recognition unit 3 and produces a control signal corresponding to an interpretation result. The control signal produced by this device control unit 4 is sent to the device to be operated 5. By this arrangement, the device to be operated 5 is operated in such a way as to exert a function corresponding to the voice. For example, in a case where the device to be operated 5 is a navigation device, if the word sent from the voice recognition unit 3 is any one of “enlargement”, “detail”, or “enlarged display”, the device control unit 4 recognizes that “map enlargement” is instructed and sends a control signal to that effect to the navigation device. In this manner, a map displayed on the screen of navigation device is enlarged in scale.

Whenever the recognition history storage unit 6 acquires the word as the recognition result from the voice recognition unit 3, the recognition history storage unit 6 sequentially stores the word as a recognition history 7. The recognition history 7 stored in this recognition history storage unit 6, is referred to by the dictionary update unit 8.

The dictionary update unit 8 deletes a word which agrees with a predetermined condition from a plurality of words that are included in the groups 21 to 2n of synonyms of the voice recognition dictionary 2 on the basis of the recognition history 7 acquired from the recognition history storage unit 6. The details of a processing performed by this dictionary update unit 8 will be described in detail later.

Next, the operation of voice operation device in accordance with embodiment of the present invention which is composed in the manner described above will be explained.

FIG. 3 is a flow chart to show an outline of a voice recognition processing in the voice operation device in accordance with embodiment 1 of the present invention.

In this voice operation device, when an operator utters voice, the voice is taken in (step ST10). That is, the voice taking unit 1 converts the voice input, for example, by a microphone to an electric signal to produce voice data and sends the voice date to the voice recognition unit 3.

Next, the voice is recognized (step ST11). That is, the voice recognition unit 3, as described above, checks the voice data sent from the voice taking unit 1 against the words registered in the groups 21 to 2n of synonyms of the voice recognition dictionary 2 and outputs a word that is the closest to the voice data as a recognition result. The word recognized by the voice recognition unit 3 is sent to the device control unit 4 and the recognition history storage unit 6. An operation of the device control unit 4 that receives the word sent from the voice recognition unit 3, is as the manner described above.

Next, recognition history is updated (step ST12). That is, the recognition history storage unit 6 that receives the word from the voice recognition unit 3 sequentially stores the word as recognition history 7. FIG. 5 shows an example of recognition history 7 which is stored in the recognition history storage unit 6. In this example, a state is shown in which the recognition history 7 is updated and stored in the recognition history storage unit 6 in order of “one screen”, “one screen display”, “one screen”, “two screens”, “one screen”, “two screen display”, and so on.

Next, it is checked whether or not the voice recognition dictionary 2 needs to be updated (step ST13). It is arranged that whether or not the voice recognition dictionary 2 needs to be updated is determined, for example, by whether or not a number of words recognized by the voice recognition unit 3 reaches a predetermined value. According to this arrangement, in a case where the number of words recognized by the voice recognition unit 3 is not sufficient for determining a frequency of use of the function, the voice recognition dictionary 2 is not updated, whereby the processing can be more efficiently performed. At this point, it is also possible to determine whether or not the voice recognition dictionary 2 needs to be updated on the basis of whether or not a predetermined time elapses from a timing when the last dictionary update processing was performed or whether or not an instruction is issued by the operator.

At this step ST13, if it is determined that the voice recognition dictionary 2 needs to be updated, the dictionary update processing is performed (step ST14). The dictionary update processing will be later described in detail. With this processing, the voice recognition processing has been completed. On the other hand, when it is determined at step ST13 that the voice recognition dictionary 2 does not need to be updated, the dictionary update processing of step ST14 is skipped and the voice recognition processing is completed.

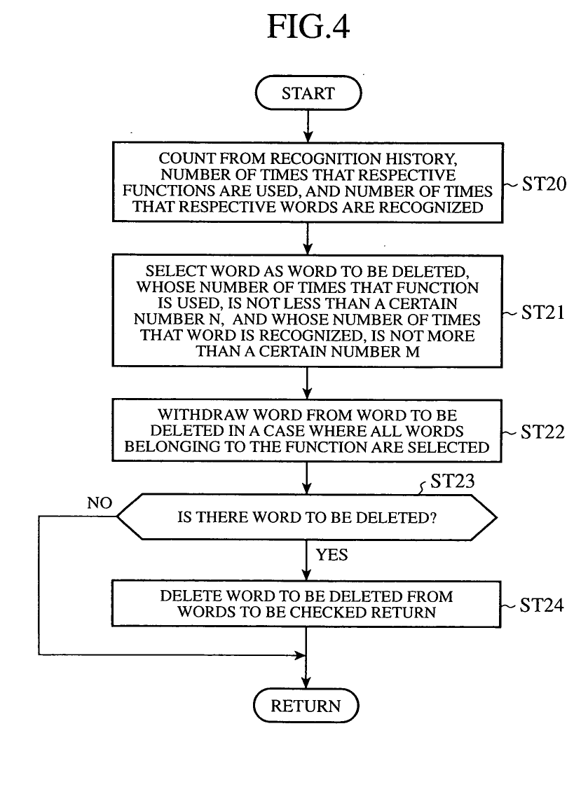

Next, the dictionary update processing which is performed at step ST14 shown in FIG. 3 will be described in detail with reference to a flow chart shown in FIG. 4.

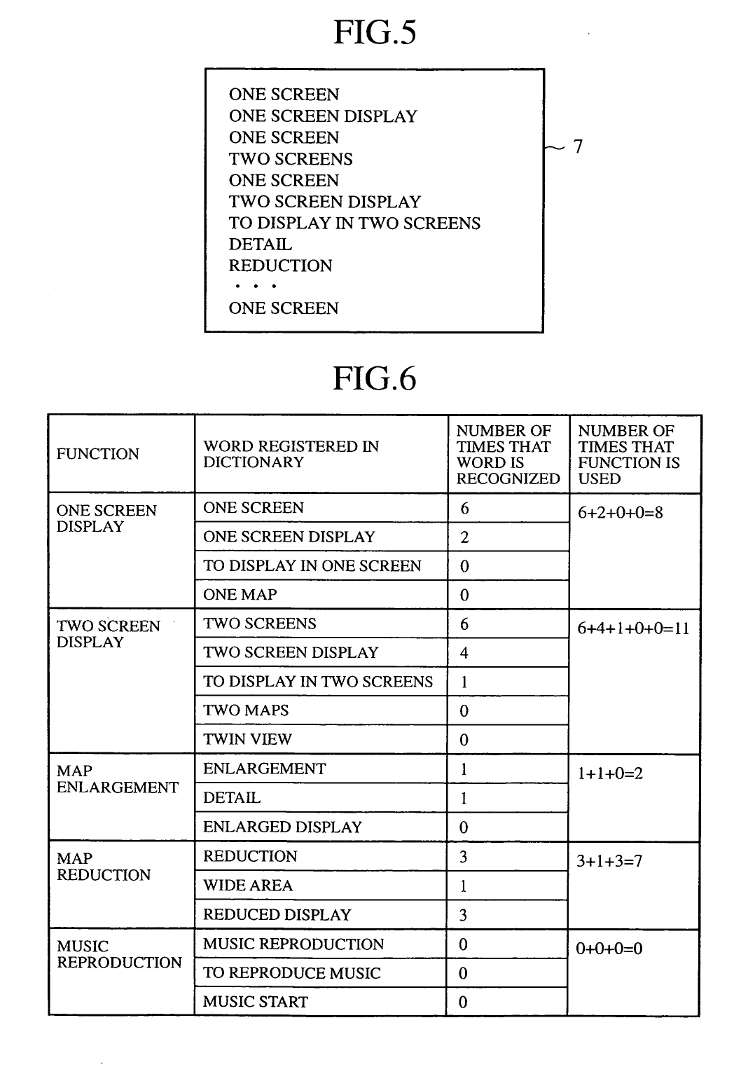

In this dictionary update processing, first, the number of times that the respective functions are used (which corresponds to “the number of usages” of the present invention) and the number of times that the respective words are recognized (which corresponds to “the number of recognitions” of the present invention) are counted from the recognition history (step ST20). That is, the dictionary update unit 8 reads the recognition history 7 from the recognition history storage unit 6 and analyzes it, thereby counting the number of times that functions of a one screen function, a two screen function, a map enlargement function, a map reduction function, and a music reproduction function are used, respectively, and the number of times that the words registered for the respective functions are recognized by the voice recognition unit 3, as shown in specific example in FIG. 6. A count block of the present invention is composed of the processing of this step ST20.

In the specific example shown in FIG. 6, by the count processing at step ST20, “8” is obtained as the number of times that the one screen display function is used and “6”, “2”, “0” and “0” are obtained, respectively, as the numbers of times that “one screen”, “one screen display”, “to display in one screen”, and “one map”, which are the words registered for the one screen display function, are recognized by the voice recognition unit 3. Similarly, “11” is obtained as the number of times that the two screen display function is used and “6”, “4”, “1”, “0”, and “0” are obtained, respectively, as the numbers of times that “two screens”, “two screen display”, “to display in two screens”, “two maps”, and “twin view”, which are the words registered for the two screen display function, are recognized by the voice recognition unit 3.

Further, “2” is obtained as the number of times that the map enlargement function is used and “1”, “1”, and “0” are obtained, respectively, as the numbers of times that “enlargement”, “detail”, and “enlarged display”, which are the words registered for the map enlargement function, are recognized by the voice recognition unit 3. Still further, “7” is obtained as the number of times that the map reduction function is used and “3”, “1”, and “3” are obtained, respectively, as the numbers of times that “reduction”, “wide area”, and “reduced display”, which are the words registered for the map reduction function, are recognized by the voice recognition unit 3. Still further, “0” is obtained as the number of times that the music reproduction function is used and “0”, “0”, and “0” are obtained, respectively, as the numbers of times that “music reproduction”, “to reproduce music”, and “music start”, which are the words registered for the music reproduction function, are recognized by the voice recognition unit 3.

Next, a word in which the number of times that a function is used is not less than a predetermined value N (where N is a positive integer) and in which the number of times that the word is recognized by the voice recognition unit 3 is not more than a predetermined value M (where M is zero or a positive integer) is selected as a word to be deleted (step ST21). A selection block of the present invention is composed of the processing of this step ST21.

At this point, assuming that N=1 and M=1, in the specific example shown in FIG. 6, the words that are selected as words to be deleted when the step ST21 is performed are: “to display in one screen”, and “one map”, which are the words registered for the one screen display function; “to display in two screens”, “two maps”, and “twin view”, which are the words registered for the two display function; “enlargement”, “detail”, and “enlarged display”, which are the words registered for the map enlargement function; “wide area” which is the word registered for the map reduction function; and “music reproduction”, “to reproduce music”, and “music start”, which are the words registered for the music reproduction function.

Next, in a case where all the words belonging to a certain function are selected as words to be selected, these words are withdrawn from the words to be selected (step ST22). A withdrawal block of the present invention is composed of the processing of this step ST22. With the processing of this step ST22, in the specific example shown in FIG. 6, “enlargement”, “detail”, and “enlarged display”, which are all the words registered for the map enlargement function, and “music reproduction”, “to reproduce music”, and “music start”, which are all the words registered for the music reproduction function, are withdrawn from the words to be deleted.

Next, it is checked whether or not there still is (remains) the word to be deleted even after the processing of step ST21 and step ST22 are performed (step ST23). Here, if it is determined that there still is the word to be deleted, the word to be deleted is deleted from the words to be checked to in the voice recognition dictionary 2 (step ST24). A change block of the present invention is composed of the processing of these steps ST23 and ST24.

With the processing of these steps ST23 and ST24, in the specific example shown in FIG. 6, “to display in one screen” and “one map”, which are the words registered for the one screen display function, “to display in two screens”, “two maps”, and “twin view”, which are the words registered for the two screen display function, and “wide range”, which is the word registered for the map reduction function, are deleted from the words to be checked in the voice recognition dictionary 2.

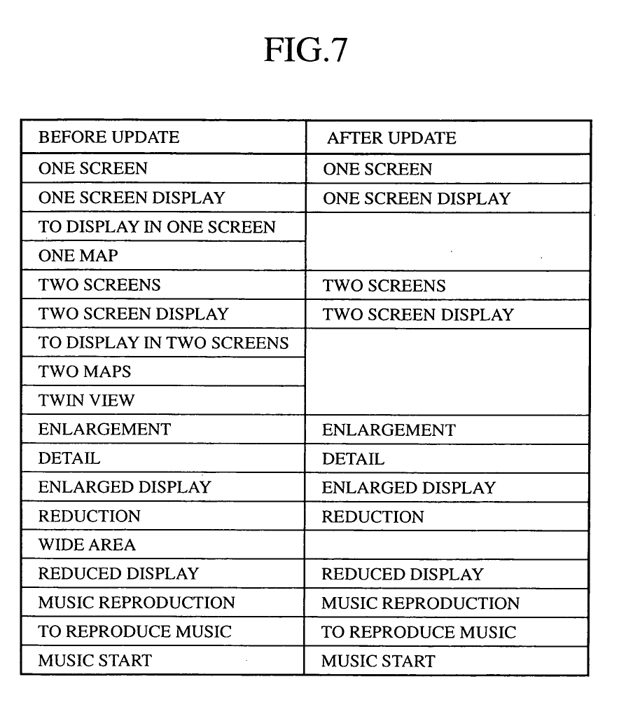

As a result, as shown in FIG. 7, the voice recognition dictionary 2 is updated to a state where: the words of “one screen” and “one screen display” are registered for the one screen display function; the words of “two screens” and “two screen display” are registered for the two screen display function; the words of “enlargement”, “detail”, and “enlarged display” are registered for the map enlargement function; the words of “reduction” and “reduced display” are registered for the map reduction function; and the words of “music reproduction”, “to reproduce music”, and “music start” are registered for the music reproduction function, respectively.

Thereafter, the sequence is returned to the voice recognition processing shown in FIG. 3 to finish the voice recognition processing. Also in a case where it is determined at step ST23 described above that there is no word to be deleted, the voice recognition processing is finished in the same way.

As described above, according to the voice operation device in accordance with embodiment 1 of the present invention, an operation of selecting the group of synonyms corresponding to the device to be operated 5 so as to enhance the rate of voice recognition is not required. Therefore, in contrast to a conventional voice operation device, the operator is not forcibly required to select the device to be operated but can easily operate the device to be operated.

Further, the voice operation device in accordance with embodiment 1 of the present invention is composed in such a way as to withdraw the words which were recognized at low frequencies in the past from the words to be checked on the basis of the recognition history 7 stored in the recognition history storage unit 6 and, in a case where all the words included in one group of synonyms corresponding to a certain function are deleted as words to be deleted from the words to be checked when this deletion is performed, in such a way as to withdraw all the words from words to be deleted in order to remain the words to be checked. Therefore, this can decrease the words to be checked in number and hence can enhance the rate of voice recognition and prevent a specific function from being unable to be performed. Further, by withdrawing the words which were recognized at low frequencies in the past from the words to be checked, it is possible to prevent the ease of use from being impaired.

Incidentally, the voice operation device in accordance with embodiment 1 described above is arranged in such a way that in a case where all the words belonging to a certain function are selected as the words to be deleted, all the words belonging to the function are withdrawn from the words to be deleted. However, it is also recommendable that the voice operation device is arranged in such a way that at least one word belonging to the function is left and that the other words are deleted from the words to be checked. That is, the voice operation device is arranged in such a way that at least one word which was recognized more times than the other word by the voice recognition unit 3 is left. At this point, in a case where a plurality of words exist which are equal to each other in the number of times that they were recognized by the voice recognition unit 3, the voice operation device is arranged in such a way that the respective words are previously given an order of priority in order that at least one word is left according to this order of priority. This structure can avoid an accidental state that the operator cannot operate a specific function of the device to be operated 5 by use of voice.

1. A voice operation device comprising:
a voice taking unit that takes in voice;
a voice recognition dictionary for storing a plurality of groups of synonyms which are provided for a plurality of functions of a device to be operated and each of which includes at least one word;
a voice recognition unit that checks voice data taken in by the voice taking unit against the words stored in the voice recognition dictionary to recognize a word corresponding to the voice;
a device control unit that controls the device to be operated on the basis of the word recognized by the voice recognition unit;
a recognition history storage unit that sequentially stores the words recognized by the voice recognition unit as recognition history; and
a dictionary update unit that updates the voice recognition dictionary in such a way that words which are determined to have been recognized at low frequencies in the past on the basis of the recognition history stored in the recognition history storage unit, are deleted except at least one of the word which is left in each group of the plurality of groups of synonyms in order to be checked.

2. The voice operation device as claimed in claim 1, wherein the dictionary update unit comprises:
a count block that counts a number of usages of each of the plurality of functions and a number of recognitions of the words belonging to each of the plurality of functions on the basis of the recognition history stored in the recognition history storage unit;
a selection block that selects a word, which belongs to a function in which a number of usages, counted by the count block, is not less than a predetermined value and in which a number of recognitions, counted by the count block, is not more than another predetermined value, as a word to be deleted;
a withdrawal block that, as for a function in which all of the words belonging to the function are selected as words to be deleted by the selection block, withdraws at least one word belonging to the function from word to be deleted; and
a change block that deletes the word which is left as the word to be deleted after withdrawal performed by the withdrawal block, from the voice recognition dictionary in order to update the voice recognition dictionary.

3. The voice operation device as claimed in claim 2, wherein, as for a function in which all of the words are selected as the words to be deleted by the selection block, the withdraw unit withdraws all of the words belonging to the function from the words to be deleted.
